(19) United States
(12) Patent Application Publication
(10) Pub. No.: US 2009/0188778 A1
(43) Pub. Date: Jul. 30, 2009

(54) CONVEYOR CHAIN WITH SIDE ROLLER

(76) Inventor: Makoto Fujiwara, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 12/138,726

(22) Filed: Jun. 13, 2008

(30) Foreign Application Priority Data
Jan. 25, 2008 (JP) 2008-014732

(51) Int. Cl. B65G 17/38

(52) U.S. Cl. 198/851

(57) ABSTRACT

A conveyor chain with a side roller, in which both assembly of and replacement of the bearing and seal members in the side roller of the conveyor chain are facilitated, and the seal performance is improved so that a long life of the seal member is realized. The chain has a sleeve 180 is inserted between a projecting side roller shaft 188 and inner rings of anti-friction bearings 172 and 174, and a grease pocket is provided between an inner seal member 176 provided on a chain side adjacent to the bearing and an outer seal member 182 spaced from the inner seal member.

### FIELD OF INVENTION

The present invention relates to a conveyor chain for conveyance articles, and particularly relates to a conveyor chain with a side roller, preferably which serves as a wheel which runs on a guard rail laid along a conveyance passage to support a load applied by the chain.

### BACKGROUND OF THE INVENTION

In a conveyance device, which conveys coal, iron ore and the like, a conveyance device called a reclaimer, in which a chain is trained between a driving sprocket and a driven sprocket, a scraper is secured to an attachment provided on a plate, which forms this chain, and conveyance articles along a floor surface of the conveyance device, has been known. As chains used in such a conveyance device, a conveyor chain with a side roller in the form of a wheel has been known. The wheel supports a load due to the chain by one or two guide rails laid along a conveyance passage so that a scraper or a floor surface of a conveyance device is not worn out or an excessive load is not applied to a driving source by being brought into contact between the scraper and the floor surface by the weights of the chain and scraper or the load of the conveyance articles (see for example Japanese Utility Model Publication No. Sho. 61-32896).

In such a conveyor chain with a side roller, both ends of a cylindrical bushing are respectively press-fitted into bushing holes of a pair of inner plates, and both ends of a connecting pin loosely inserted into the bushing are press-fitted into pin holes in a pair of outer plates disposed on both outsides of the pair of inner plates. Both ends or one end of the connecting pin is extended beyond the outer plate to the outside to form a side roller shaft and a side roller is mounted on the side roller shaft by a bearing.

### PROBLEMS TO BE SOLVED BY THE INVENTION

However, since in the conventional conveyor chain with a side roller, the bearing and the seal member are directly attached to a side roller shaft, there was a problem in maintenance that the replacement of the bearing and seal member is difficult.

Further, since the bearing is directly attached to the side roller shaft, the space between the inner circumferential surface of the bearing and tread on the outer circumferential surface of the side roller must be decreased so that there was often a problem in the assembly operation in that the initial assembly of the conveyor chain was often deficient.

Further, since a seal member, which prevents of entering of foreign materials into the bearing, is a one-layered structure, there were problems that sealing properties are bad and endurance of the seal member is low.

Thus, the technical problem to be solved by the invention, and the object of the present invention is to provide a conveyor chain with a side roller, in which replacement of the bearing and seal member in the conveyor chain with a side roller is facilitated and an improvement of the assembly properties of the side roller is realized and the seal performance is improved so that the long life of the seal member is realized.

### SUMMARY OF THE INVENTION

The invention solves the above-described problems by a conveyor chain with a side roller in which both ends of a cylindrical bushing are respectively press-fitted into bushing holes of a pair of inner plates, both ends of a connecting pin loosely inserted into the bushing are press-fitted into pin holes of a pair of outer plates disposed on both outsides of the pair of inner plates, and both ends or one end of the connecting pin is extended beyond said outer plate to the outside to form a side roller shaft. A hollow side roller is provided about the side roller shaft through an anti-friction bearing. The invention is characterized in that a sleeve is inserted between the side roller shaft and an inner ring of the bearing, and that a grease retainer or grease pocket is provided between an inner seal member provided on the chain side adjacent to the bearing and an outer seal member provided so as to be spaced from the inner seal member.

The invention further solves the above-described problems by including a spacer ring between an end surface of the sleeve and the outer plate. An O ring is mounted between the spacer ring and an inner circumferential cutaway portion on one end surface of the sleeve.

Further, the invention solves the above-described problems by attaching an end cap to the outer tread of the side roller beyond the bearings which mount the side roller on the shaft to enclose the space between the side roller outer ring and the shaft. The cap is either sealed with a caulking material or the side roller outer ring and the cap are tightly press-fitted.

It is noted that the expression “tightly press-fitted” in the present invention means that the outer ring of the side roller and the cap are closely brought into contact with each other so no space is formed therebetween and that both members are not slit.

According to the present invention, a conveyor chain with a side roller has pairs of inner and outer link plates, a bushing between the inner plates, and a connecting pin between the outer plates loosely inserted into the bushing. Both ends of the bushing are respectively press-fitted into bushing holes in the pair of inner plates. Both ends of the connecting pin are press-fitted into pin holes in the pair of outer plates which are disposed on both outsides of the pair of inner plates. Both ends or one end of the connecting pin is extended beyond the outer plate to the outside to form a side roller shaft. A side roller is mounted on the side roller shaft by an anti-friction bearing. A sleeve is inserted between the side roller shaft and the inner ring of the bearing. An inner seal member is provided on the side of the chain adjacent to the bearing and an outer seal member is spaced from the inner seal member to provide a grease retainer or grease pocket. Thus, since the side roller shaft and the bearing are not directly fitted to each other, the replacement of the bearing is easy. And since the grease retainer provided between two seal members traps foreign materials, which might enter from outside of the seal member, the inner seal member is protected and long life of the seal can be realized.

According to another feature of the invention, a spacer ring is provided between the end surface of the sleeve and the outer plate, and an O ring is mounted between the spacer ring and an inner circumferential step portion on the end surface of the sleeve. Thus, the space between the inner circumferential surface of the sleeve and the outer part of the side roller shaft is sealed so that the entering of foreign materials into the hollow space within the roller is prevented.

Further, according to an additional feature of the invention, a cap is mounted to the outside of the side roller covering the space within the side roller outer periphery. The cap is either sealed with a caulking material or the cap is tightly press-fitted into the side roller, so that the entering of foreign materials from the outside is prevented, so that additional high dust tightness can be realized in addition to the seal effects obtained by the above-described two seal members and O ring.

If both ends of a cylindrical bushing are respectively press-fitted into bushing holes of a pair of inner plates, both ends of a connecting pin loosely inserted into the bushing are press-fitted into pin hole of a pair of outer plates disposed on both outsides of the pair of inner plates, both ends or one end of the connecting pin is extended from the outer plate to the outside to form a side roller shaft and a side roller outer ring is provided about the side roller shaft through a bearing, and if a sleeve is inserted between the side roller shaft and an inner ring of the bearing, and a grease retainer is provided between an inner seal member provided on a chain side adjacently to the bearing and an outer seal member provided so as to be spaced from the inner seal member, so that the replacement of the bearing and the seal member of a conveyor chain with a side roller is facilitated and the improvement of assembly is realized, and the seal performance is improved whereby the long life of the seal member is realized. Any concrete embodiments of the conveyor chain with a side roller of the present invention may be adopted.

### BRIEF DESCRIPTION OF THE DRAWINGS

An example according to the present invention will be described with reference to FIGS. 1 to 4.

FIG. 1 is a cross-sectional view of a conveyor chain with a side roller according to the present invention;

FIG. 2 is an exploded view of a side roller portion of the present invention;

FIG. 3 is a cross-sectional view showing assembly steps of the side roller portion of the present invention; and

FIG. 4 is a fragmentary plan view of the conveyor chain.

### DESCRIPTION OF THE PREFERRED EMBODIMENTS

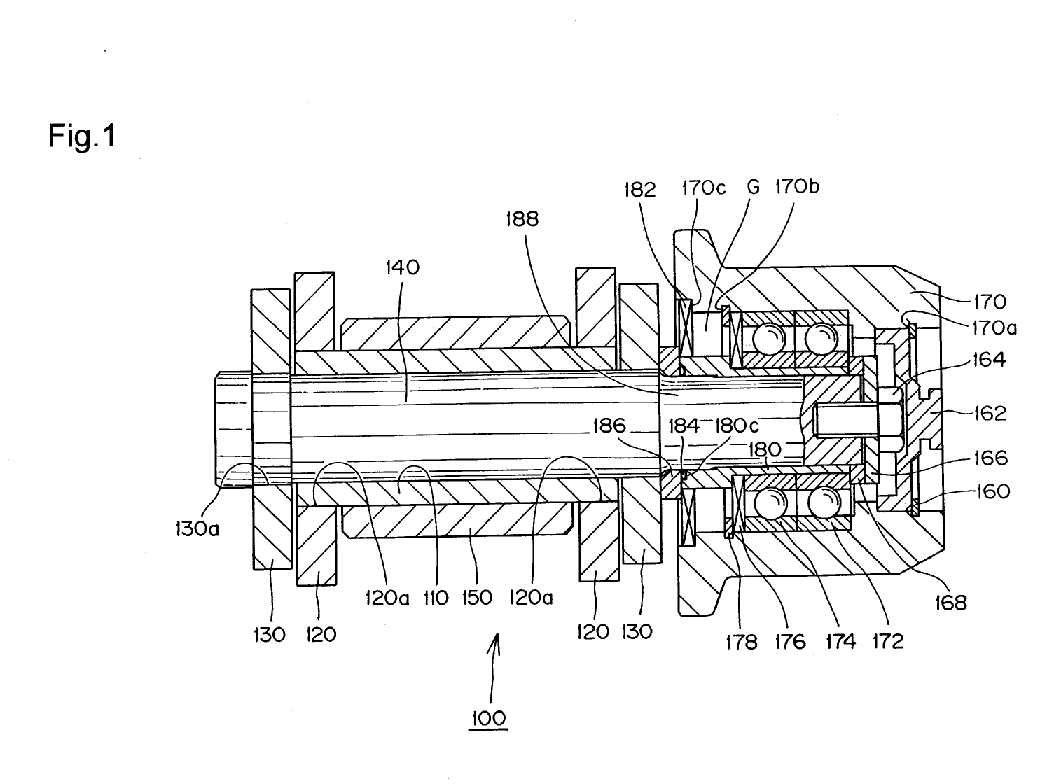

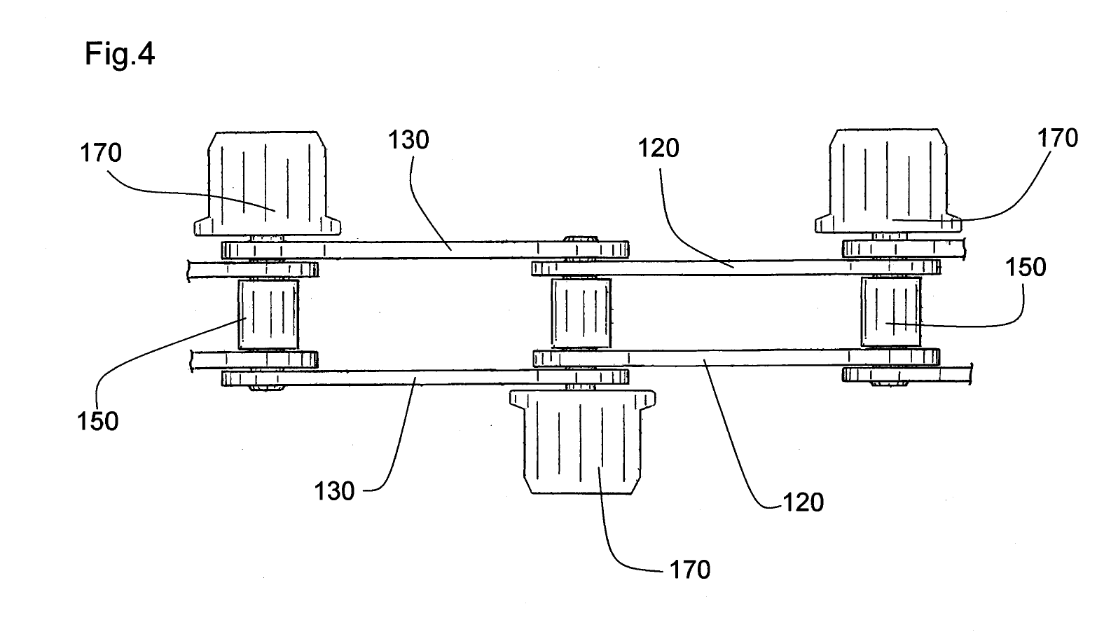

In a conveyor chain 100 with a side roller, which is an example according to the present invention, as shown in FIGS. 1 and 4, both ends of a cylindrical bushing 110 are respectively press-fitted into bushing holes 120a of a pair of inner plates 120, and both ends of a connecting pin 140 loosely inserted into the bushing 110 are press-fitted into pin holes 130a of a pair of outer plates 130 disposed on both outsides of the pair of inner plates 120. Further, a roller 150 is loosely fitted onto the bushing 110. A connecting pin 140 is extended beyond the outer plate 130 to the outside to form a projecting side roller shaft 188, and a side roller outer ring 170 is journaled on this side roller shaft 188 by two anti-friction bearings 172 and 174 arranged in parallel to the side roller shaft 188.

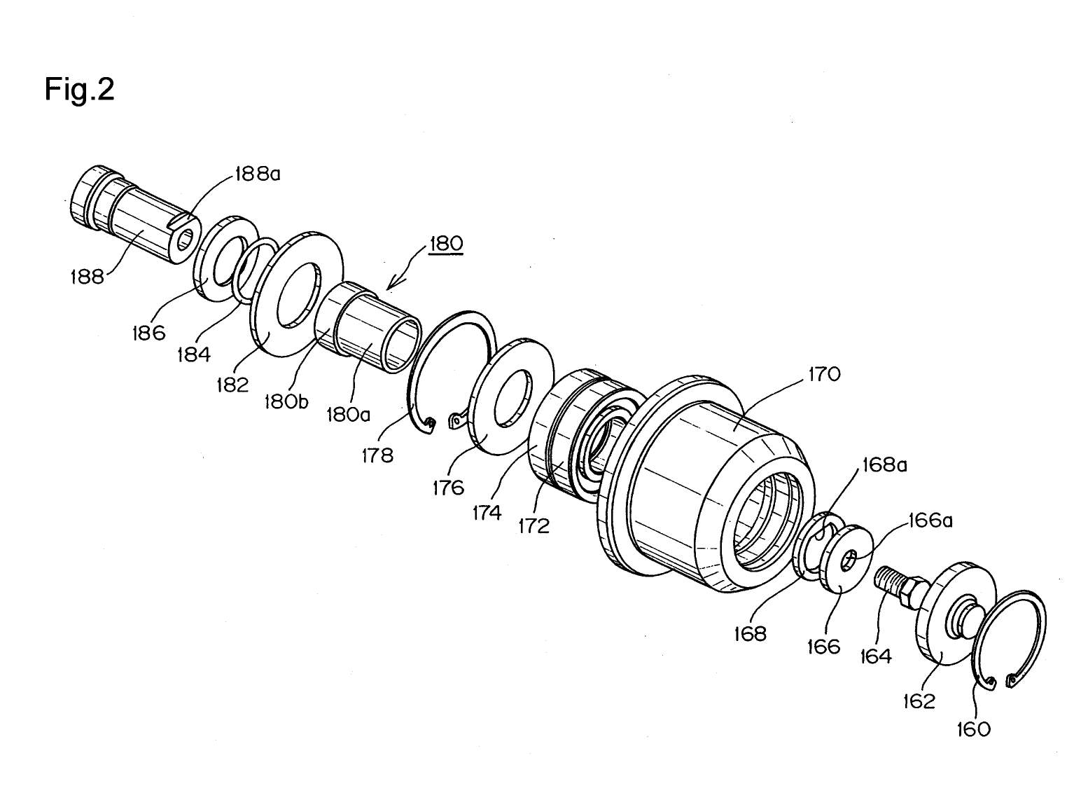

Further, as shown in FIGS. 1 and 2, between the side roller shaft 188 and inner rings of the bearings 172 and 174 is inserted a cylindrical metallic sleeve 180 having a thick wall portion 180b and a thin wall portion 180a. The bearings 172 and 174 are provided on the thin wall portion 180a of the sleeve 180. An inner seal member 176 is provided on a chain side so as to abut on the bearing 172. This inner seal member 176 is made of a steel plate and has a ring-shaped labyrinth structure in accordance with the bearing 172. The inner diameter portion of the inner seal member 176 is fitted onto an outer circumferential surface of the sleeve 180 and the outer diameter portion of the inner seal member 176 is fitted into an inner circumferential surface of the side roller outer ring 170 so that high seal performance is exhibited. The inner seal member 176 is provided on the thin wall portion 180a of the sleeve 180 as well as the bearings 172 and 174. A C-shaped stopper ring 178 attached to a concave portion or groove 170b provided inside the side roller 170 restricts the movement of the inner seal member 176 and the bearings 172 and 174 in the axial direction.

Further, an outer seal member 182 is press-fitted between an outer circumferential surface of an end portion of the thick wall portion 180b of the sleeve 180 and an inner circumferential step portion 170c of a chain side opening portion of the side roller outer ring 170. The structure and the material of the outer seal member 182 are substantially the same as those of the inner seal member 176. However, the inner circumferential diameter and the outer circumferential diameter of the outer seal member 182 are larger than those of the inner seal member 176 by the height of the step between the thick wall portion 180b and the thin wall portion 180a. Between the inner seal member 176 and the outer seal member 182 is a sealed grease pocket to form a grease retainer G.

Further, between the thick wall portion 180b of the sleeve 180 and the outer plate 130 is arranged a spacer ring 186 and between the spacer ring 186 and the inner circumferential cutaway portion 180c is mounted an O ring 184.

A front end portion of the side roller shaft 188 forms a D-shaped cut portion 188a obtained by linearly cutting a part of the outer circumferential surface. The sleeve 180 is passed through the side roller shaft 188. A D-washer 168 having a D-shaped opening portion 168a, which fits to the D-shaped cut portion 188a of the side roller shaft 188, is engaged on the D-shaped cut portion 188a. A series of members from the spacer ring 186 to a metallic stopper 166 having a bolt insertion hole 166a at the center are secured to the side roller shaft 188 by a bolt 164 through the metallic stopper 166. A cap 162 in the side roller outer ring is covered over an opening portion opposite to the side of the outer plate 130, and the disengagement of the cap 162 is prevented by the C-shaped stopper ring 160 fitted onto a concave portion or groove 170a provided on an inner circumferential surface of the hollow side roller 170. Further, a caulking material is applied over the entire circumference of the C-shaped stopper ring 160 so that the space between the inner circumferential surface of the side roller outer ring 170 and the cap 162 is sealed.

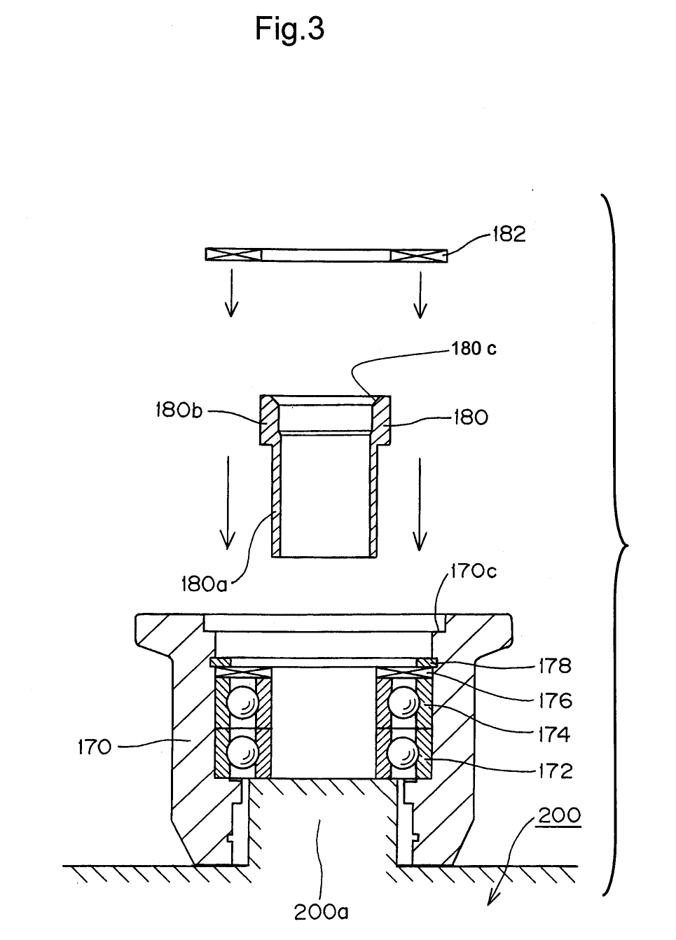

Next, referring to FIGS. 1 and 2, assembly steps of a side roller portion of the present example will be explained based on FIG. 3. When the side roller portion is assembled, a jig 200 is used, which abuts on an end surface of an opening portion of the hollow side roller on the opposite side to the chain. The jig 200 has a projecting portion 200a, which limits the displacement of the inner rings of the bearings to prevent the damage to the bearings 172 and 174 due to application of undue force to outer rings of the bearings 172 and 174. When the side hollow roller 170 is placed on this jig 200, the two bearings 172 and 174 and the inner seal member 176 are pressed into the hollow interior of the side roller 170 and then a C-shaped stopper ring 178 is mounted in the groove 170c on the hollow interior of the side roller 170 to lock the inner seal member 176 in place.

Then a sleeve 180 is press-fitted into the inner seal member 176 and the inner rings of the bearings 172 and 174 along inner circumferential surfaces thereof. Grease is pumped into a space formed by a thick wall portion 180b of the sleeve 180, the inner seal member 176 and an inner wall of the hollow side roller 170. An outer seal member 182 is press-fitted between an outer circumferential surface of an end portion of the thick wall portion 180b of the sleeve 180 and an inner circumferential step portion of a chain side opening portion of the side roller outer ring 170.

A spacer ring 186 and an O ring 184 are fitted onto the projecting side roller shaft 188 of the connecting pin 140 of the chain and a side roller assembled as described above is fitted from the above. A D-washer 168 and a stopper 166 are engaged on the exposed end of the shaft 188 and a bolt is screwed from the above. A cap 162 covers the open end of the hollow portion of the roller 170 opposite to the end confronting the outer plate 130, and the disengagement of the cap 162 is prevented by a C-shaped stopper ring 160 fitted to an concave portion or groove 170a provided on an inner circumferential surface of the hollow side roller 170. Further, a caulking material is applied to the entire surface of the C-shaped stopper ring 160 so that the space between the inner circumferential surface of the side roller outer ring 170 and the cap 162 is sealed. The assembly of a side roller portion of the present example is completed by such steps.

The present invention facilitates the replacement of the bearing and the seal member in a conveyor chain with a side roller, which is utilized in a reclaimer or the like and improves the dust tightness. Thus the present invention has very high industrial applicability.

1. A conveyor chain having a hollow side roller, said chain having pairs of inner and outer link plates, said plates each having a pair of holes, a cylindrical bushing having both of its ends press fitted into each of said holes in said inner link plates, a connecting pin extending between said outer link plates and loosely fitting within each bushing, at least one end of said connecting pin extending beyond said outer link plate to form a projecting side roller shaft, and a bearing within said hollow side roller rotatably supporting said side roller on said projecting side roller shaft,
wherein said bearing is an anti-friction bearing having an inner ring, said inner ring being mounted on said projecting shaft by a sleeve surrounding said projecting shaft, said bearing being spaced from said outer link plate to provide a grease pocket within said side roller, and
a pair seal members sealing said grease pocket, including an inner seal member within said side roller adjacent said outer link and an outer seal member within said side roller adjacent said bearing inner ring, said inner and outer seal members being spaced apart to form said grease pocket within said side roller between the inside of said side roller and said sleeve.

2. A conveyor chain according to claim 1 including a spacer ring between the inner end of said sleeve and said outer link plate, the inner end of said sleeve having a circumferential cutaway surrounding said shaft, and an O-ring within said circumferential cutaway in the inner end of said sleeve and said spacer ring.

3. A conveyor chain according to claim 1 wherein the outer end of said hollow side roller is open, and includes a cap attached to said open end to provide a seal between said cap and said side roller.

4. A conveyor chain according to claim 3, including caulking material between said cap and the inside of said roller to provide said seal.

5. A conveyor chain according to claim 3, wherein said cap is press fitted to the inside of said hollow side roller to provide said seal.
